(19) United States
(12) Patent Application Publication
(10) Pub. No.: US 2019/0237038 A1
(43) Pub. Date: Aug. 1, 2019

(54) IMAGE SIGNAL OUTPUT DEVICE, DISPLAY SYSTEM, AND IMAGE SIGNAL OUTPUT METHOD

(71) Applicant: NEC Display Solutions, Ltd., Tokyo (JP)

(72) Inventor: Koichi OKADA, Tokyo (JP)

(21) Appl. No.: 16/341,788

(22) PCT Filed: Oct. 26, 2016
(86) PCT No.: PCT/JP2016/081742

§ 371 Date: Apr. 12, 2019

(51) Int. Cl. G09G 3/36; H04N 17/04

(52) U.S. Cl. CPC G09G 3/3688; G09G 2330/08; G09G 2310/027; H04N 17/045

(57) ABSTRACT

A video signal output device includes a redundant circuit and a first video signal output circuit. The redundant circuit includes a redundant input switcher configured to input a first input signal and to thereby generate a first video signal according to the first input signal. The first video signal output circuit includes a first input signal switcher configured to input the first input signal and a second input signal and to thereby generate either the first video signal or a second video signal according to the second input signal, and a first video signal switcher configured to input the first video signal from the redundant input switcher while inputting the first video signal or the second video signal from the first input signal switcher and to thereby output the first video signal generated by the redundant input switcher or the first input signal switcher.

### TECHNICAL FIELD

The present invention relates to a video signal output device, a display system, and a video signal output method.

### BACKGROUND ART

A technology for continuously displaying a video using a redundant circuit serving as backups even when a video signal generating circuit stops its operation due to failure while outputting video signals has been disclosed in documents (e.g. Patent Document 1). A display device disclosed by Patent Document 1 is designed to detect a failure of circuitry, to control input/output signals of the failure-detected circuitry, to switch input signals, which have been input to the failure-detected circuitry, to be input to the redundant circuit, and to thereby switch output signals, which have been output from the failure-detected circuitry, to be output from the redundant circuit, thus repairing the function of the failure-detected circuitry.

### CITATION LIST

### Patent Document

Patent Document 1: Japanese Patent Application Publication No. 2010-81255

### SUMMARY OF INVENTION

### Technical Problem

The display device of Patent Document 1 may be able to detect whether or not its internal circuitry may fail, but complicated controls may be needed to grasp which circuit may fail in the entirety of the display device. In addition, complicated wirings may be needed to switch input signals, which have been input to the failure-detected circuitry, to be input to the redundant circuit and to thereby switch output signals, which have been output from the failure-detected circuitry, to be output from the redundant circuit.

The present invention is made in consideration of the aforementioned circumstances, and therefore the present invention aims to provide a video signal output device configured to continuously output video signals, which have been output before a failure of circuitry, according to a simple method.

### Solution to Problem

To solve the above problem, the present invention provides a video signal output device including a redundant circuit and a first video signal output circuit, wherein the redundant circuit includes a redundant input switcher configured to input a first input signal and to thereby generate a first video signal according to the first input signal, and wherein the first video signal output circuit includes a first input signal switcher configured to input the first input signal and a second input signal and to thereby generate either the first video signal or a second video signal according to the second input signal, and a first video signal switcher configured to input the first video signal from the redundant input switcher while inputting the first video signal or the second video signal from the first input signal switcher and to thereby output the first video signal generated by the redundant input switcher or the first input signal switcher.

In addition, the present invention provides a video signal output method adapted to a video signal output device including a redundant circuit and a first video signal output circuit, which includes a redundant input switching process configured to apply a first input signal to the redundant circuit and to thereby generate a first video signal according to the first input signal; a first input switching process configured to apply the first input signal and a second input signal to the first video signal output circuit and to thereby generate the first video signal or a second video signal according to the second input signal; and a first video switching process configured to input the first video signal generated in the redundant input switching process while inputting the first video signal or the second video signal generated in the first input switching process and to thereby output the first video signal generated in the redundant input switching process or the first input switching process.

### Advantageous Effects of Invention

The present invention is configured to continuously output video signals, which have been output before a failure of circuitry, according to a simple method.

### BRIEF DESCRIPTION OF DRAWINGS

FIG. 1 is a functional block diagram showing the configuration of a video signal output device according to the first embodiment.

FIG. 2 is a flowchart showing a series of processes configured to determine whether or not a video signal processor fails.

FIG. 3 is a flowchart showing a series of processes configured to determine whether or not a video processor fails.

FIG. 4 is a flowchart showing a series of processes when it is determined that a video processor fails.

FIG. 5 is an explanatory diagram of a video signal output device according to the third embodiment.

FIG. 6 is an explanatory diagram of a video signal output device according to the fourth embodiment.

FIG. 7 is an explanatory diagram of a video signal output device according to the fifth embodiment.

FIG. 8 is an explanatory diagram of a video signal output device according to the sixth embodiment.

FIG. 9 is an explanatory diagram of a video signal output device according to the seventh embodiment.

### DESCRIPTION OF EMBODIMENTS

Hereinafter, a video signal output device according to one embodiment of the present invention will be described with reference to the drawings.

First, the first embodiment will be described below.

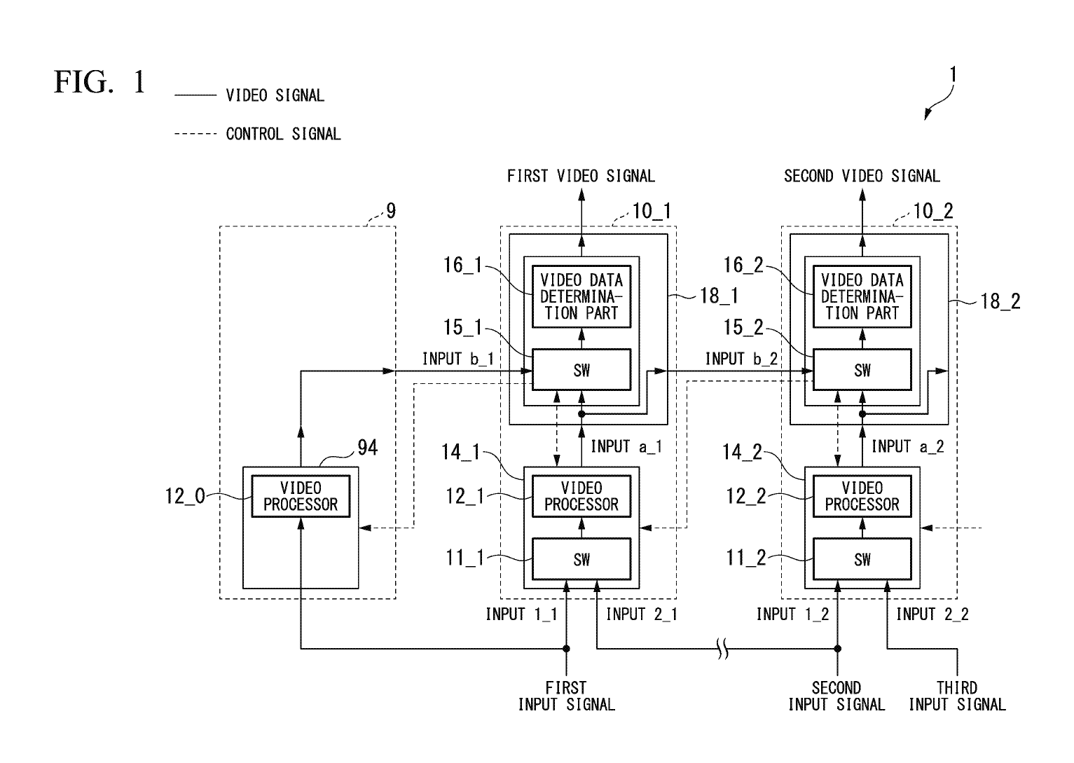

FIG. 1 is a functional block diagram showing a configuration example of a video signal output device according to the first embodiment. FIG. 1 shows a configuration example including a redundant circuit 9, a video signal output circuit 10_1, and a video signal output circuit 10_2.

The redundant circuit 9 includes a redundant input switcher 94. The redundant input switcher 94 receives a first input signal. The redundant input switcher 94 outputs a first video signal according to the first input signal.

The video signal output circuit 10_1 includes an input signal switcher 14-1 and a video signal switcher 18_1. The input signal switcher 14_1 receives a first input signal and a second input signal. The input signal switcher 14_1 outputs either a first video signal according to the first input signal or a second video signal according to the second input signal. The video signal switcher 18_1 is supplied with the first video signal from the redundant input switcher 94 while the video signal switcher 18_1 is supplied with the first video signal or the second video signal from the input signal switcher 14_1. The video signal switcher 18_1 outputs the first video signal output from the redundant input switcher 94 or the first video signal output from the input signal switcher 14_1. When supplied with the second video signal from the input signal switcher 14_1, the video signal switcher 18_1 does not output the second video signal output from the input signal switcher 14_1.

The video signal output circuit 10_2 has the same configuration as the video signal output circuit 10_1, and therefore the video signal output circuit 10_2 includes an input signal switcher 14_2 and a video signal switcher 18_2. The input signal switcher 14_2 receives a second input signal and a third input signal. The input signal switcher 14_2 outputs either a second video signal according to the second input signal or a third video signal according to the third input signal. The video signal switcher 18_2 receives the first video signal or the second video signal from the previous-stage input signal switcher 14_1, while the video signal switcher 18_2 receives the second video signal or the third video signal from the input signal switcher 14_2. The video signal switcher 18_2 outputs the second video signal which is output from either the input signal switcher 14_1 or the input signal switcher 14_2. When supplied with the first video signal from the input signal switcher 14_1, the video signal switcher 18_2 does not output the first video signal output from the input signal switcher 14_1. When supplied with the third video signal from the input signal switcher 14_2, the video signal switcher 18_2 does not output the third video signal output from the input signal switcher 14_2.

As shown in FIG. 1, the redundant input switcher 94 includes a video processor 12_0. The video processor 12_0 generates a video signal according to its input signal. In addition, the video processor 12_0 uses adjustment data to generate a video signal. For example, the adjustment data may represent the number of pixels to display video signals on a display device, the information for displaying videos on the display device such as frame rates, and the information for adjusting the display device by users such as luminance and resolutions of the display device. The adjustment data are stored on an unillustrated storage area.

The input signal switcher 14_1 includes an input signal switch 11_1 and a video processor 12_1. The input signal switch 11_1 outputs either the first input signal or the second input signal to the video processor 12_1 according to a control signal from the video signal output circuit 10_2. The video processor 12_1 has the same configuration as the video processor 12_0. The video processor 12_1 uses adjustment data of the first input signal and the adjustment data of the second input signal to generate the first video signal and the second video signal. The adjustment data of the first input signal is stored on an unillustrated first video information storage area while the adjustment data of the second input signal is stored on an unillustrated second video information storage area.

The video signal switcher 18_1 includes a video signal switch 15_1 and a video data determination part 16_1. The video signal switch 15_1 receives the first video signal from the redundant input switcher 94 while the video signal switch 15_1 receives the first video signal or the second video signal from the input signal switcher 14_1. Under the control of the video data determination part 16_1, the video signal switch 15_1 outputs to the video data determination part 16_1 the first video signal output from the redundant input switcher 94 or a video signal (i.e. the first video signal or the second video signal) output from the input signal switcher 14_1.

The video data determination part 16_1 outputs the first video signal, which is output from either the redundant input switcher 94 or the input signal switcher 14_1, to the exterior of the video signal output circuit 10_1. The video data determination part 16_1 determines whether or not the video processor 12_1 fails according to the first video signal from the redundant input switcher 94 or the first video signal supplied by the input signal switcher 14_1. When the video processor 12_1 fails, the video data determination part 16_1 outputs the first video signal produced by the redundant input switcher 94 instead of the first video signal produced by the input signal switcher 14_1. In addition, video data determination part 16_1 determines whether the video signal supplied by the input signal switcher 14_1 is the first video signal or the second video signal. When the video signal supplied by the input signal switcher 14_1 is the second video signal, the video data determination part 16_1 outputs the first video signal produced by the redundant input switcher 94.

Similar to the video data determination part 16_1, a video data determination part 16_2 determines whether a video processor 12_2 fails according to the second video signal from the input signal switcher 14_2. When the video processor 12_2 fails, the video data determination part 16_2 outputs the second video signal produced by the input signal switcher 14_1 instead of the second video signal produced by the input signal switch 14_2. In addition, the video data determination part 16_2 determines whether the video signal supplied by the input signal switcher 14_2 is the second video signal or the third video signal. When the video signal supplied by the input signal switcher 14_2 is the third video signal, the video data determination part 16_2 controls the previous-stage input signal switcher 14_1, to output the second video signal, thus outputting the second video signal which is output from the input signal switcher 14_1.

As described above, even when the input signal switcher 14_2 cannot normally output the second video signal due to a failure of the video processor 12_2, the video signal output circuit 10_2 controls the previous-stage input signal switcher 14_1, to generate and output the second video signal, and therefore it is possible to continuously output the second video signal, which has been output before the failure. Even when the input signal switcher 14_1 cannot normally output the first video signal due to a failure of the video processor 12_1 or because the video processor 12_1 generates the second video signal, the video signal output circuit 10_1 is configured to output the first video signal from the previous-stage redundant input switcher 94, and therefore it is possible to continuously output the first video signal, which has been output before the failure.

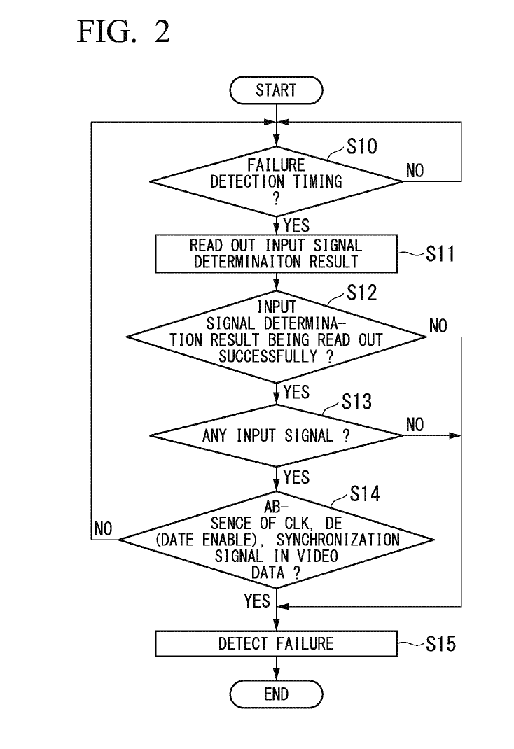

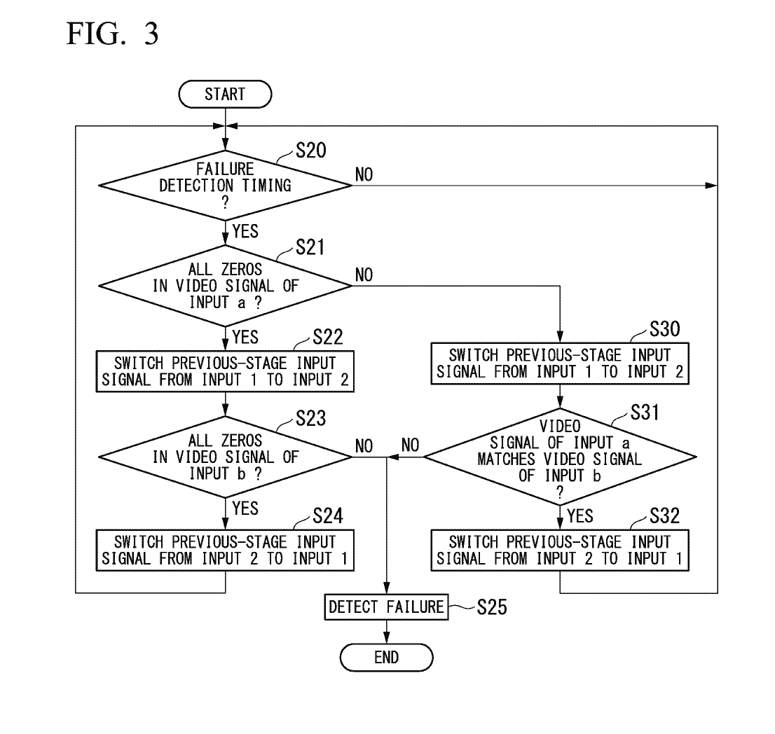

Next, the processing of the video data determination part 16_1 to determine whether or not the video processor 12_1 fails will be described with reference to the flowcharts of FIGS. 2 and 3. FIGS. 2 and 3 are flowcharts showing series of processes to determine whether nor not the video processor 12_1 fails. In a series of processes shown in the flowchart of FIG. 2, the video data determination part 16_1 determines whether or not the video processor 12_1 fails according to the data configuration of the first video signal from the input signal switcher 14_1. In a series of processes shown in the flowchart of FIG. 3, the video data determination part 16_1 determines whether or not the video processor 12_1 fails by way of comparison between the first video signal from the redundant input switcher 94 and the first video signal from the input signal switcher 14_1.

Similar to the video data determination part 16_1, the video data determination part 16_2 determines whether or not the video processor 12_2 fails. Descriptions regarding part of the processing of the video data determination part 16_2, which is similar to the processing of the video data determination part 16_1, will be omitted here; hence, another part of the processing of the video data determination part 16_2, which is not carried out by the video data determination part 16_1, will be described below.

The video data determination part 16_1 carries out a series of processes shown in FIG. 2 at periodical intervals of time determined in advance (e.g. a time interval of one second) and thereby determine whether or not the video processor 12_1 fails. When the video data determination part 16_1 fails to determine that the video processor 12_1 fails in the periodical failure detection process shown in the flowchart of FIG. 2, the video data determination part 16_1 carries out a series of processes shown in FIG. 3 and thereby determines whether or not the video processor 12_1 fails.

As shown in FIG. 2, when it comes to a failure detection timing (i.e. YES in step S10), the video data determination part 16_1 reads out a result of determining the presence/absence of the first input signal (step S11). For example, the presence/absence of an input signal is determined whether or not, upon detecting the information such as a refresh rate, a horizontal synchronization frequency and a vertical synchronization frequency of an input signal, the detected information may match a predetermined condition in which both the horizontal synchronization frequency and the vertical synchronization frequency of an input signal are not zeros. The video data determination part 16_1 determines the presence/absence of an input signal at an arbitrary timing determined in advance and therefore stores the determination result on an unillustrated storage area. Accordingly, the video data determination art 16_1 reads out the determination result, i.e. the presence/absence of an input signal stored on an unillustrated storage area, at eh failure detection timing.

When the video data determination part 16_1 successfully reads out the input determination result (i.e. YES in step S12), the video data determination part 16_1 confirms the presence/absence of the first input signal (step S13).

When the video data determination part 16_1 fails to read out the input determination result (i.e. NO in step S12), the video data determination part 16_1 determines that the video processor 12_1 fails (step S15).

When the video data determination part 16_1 reads out the input determination result indicating the presence of the first input signal (i.e. YES in step S13), the video data determination part 16_1 determines the presence/absence of a clock signal (CLK) which is output from the video processor 12_1 in connection with the first video signal, a data enable signal (DE) representing a portion of a video signal actually used to display video data, and a synchronization signal (step S14).

When the video data determination part 16_1 determines the existence of a CLK signal, a DE signal, and a synchronization signal (i.e. NO in step S14), the flow returns to step S10.

Upon detecting absence of at least one of a CLK signal, a DE signal, and a synchronization signal (i.e. NO in step S13), the video data determination part 16_1 determines that the video processor 12_1 fails (step S15). Then, the video data determination part 16_1 exits a series of processes shown in the flowchart of FIG. 2.

In a series of processes shown in the flowchart of FIG. 2, when the video data determination part 16_1 fails to determine that the video processor 12_1 fails, the video data determination part 16_1 further carries out a series of processes shown in FIG. 3 and thereby determine whether or not the video processor 12_1 fails. At a time of predetermined variations (for example, at a power-on time, at a time of any variations of video signals, or at a time of any interruptions of video signals), the video data determination part 16_1 needs to carry out a series of processes shown in FIG. 3, and therefore it is possible to determine whether or not the video processor 12_1 fails with a high accuracy.

In a series of processes shown in the flowchart of FIG. 2, when the video data determination part 16_1 fails to determine that the video processor 12_1 fails, or at a failure detection timing for detecting failure such as a time of predetermined variations like a power-on time, a time of any changes of video signals, and at a time of interruptions of video signals (step S20), the video data determination part 16_1 determines whether or not the first video signal as an input a_1 of the video signal switch 15_1 from the input signal switcher 14_1 indicates a full-black signal (or all zeroes) (step S21).

When the video signal serving as the input a_1 indicates a full-black image (i.e. YES in step S21), the video data determination part 16_1 determines whether or not the first video signal input from the previous-stage redundant input switcher 94, i.e. an input b_1 of the video signal switch 15_1, indicates a full-black signal (step S23).

When the video signal serving as an input a_2 indicates a full-black signal (i.e. YES in step S21), the video data determination part 16_2 controls the previous-stage input signal switcher 14_1 such that the video processor 12_1 inputs the first input signal (step S22), thus determining whether the second video signal from the previous-stage input signal switcher 14_1 as an input b_2 of the video signal switch 15_2 indicates a full-black signal (step S23).

When the video signal of the input b_2 indicates a full-black signal (i.e. YES in step S23), the video data determination part 16_1 determines that the video processor 12_1 did not fail. Then, the flow returns to step S20.

When the video signal of the input b_2 indicates a full-black signal (i.e. YES in step S23), the video data determination part 16_2 determines that the video processor 12_2 did not fail. Accordingly, the video data determination part 16_2 controls the previous-stage input signal switcher 14_1 such that the video processor 12_1 inputs the first input signal (step S24). Then, the flow returns to step S20.

When the video signal of the input b_1 does not indicate a full-black signal (i.e. NO in step S23), the video data determination part 16_1 determines that the video processor 12_1 fails (step S25). Accordingly, the video data determination part 16_1 exits a series of processes shown in the flowchart of FIG. 3.

When the video signal of the input a_1 does not indicate a full-black signal (i.e. NO in step S21), the video data determination part 16_1 determines whether or not the video signal of the input a_1 matches the first video signal of the input b_1 by way of comparison between them (step S31).

When the video signal of the input a_2 does not indicate a full-black signal (i.e. NO in step S21), the video data determination part 16_2 controls the previous-stage input signal switcher 14_1 such that the video processor 12_1 generates the second video signal (step S30). The video data determination part 16_2 determines whether or not the video signal of the input a_2 matches the second video signal of the input b_2 through comparison between them (step S31). When the video signal of the input a_1 matches the first video signal of the input b_1 (i.e. YES in step S31), the video data determination part 16_1 determines that the video processor 12_1 did not fail. Then, the flow returns to step S20.

In addition, when the video signal of the input a_2 matches the second video signal of the input b_2, the video data determination part 16_2 determines that the video processor 12_2 did not fail. Accordingly, the video data determination part 16_2 controls the previous-stage input signal switcher 14_1 such that the video processor 12_1 generates the first video signal. Then, the flow returns to step S20.

When the first video signal of the input a_1 does not match the first video signal of the input b_1, the video data determination part 16_1 determines that the video processor 12_1 fails (step S25). Then, the video data determination part 16_1 exits a series of processes shown in the flowchart of FIG. 3.

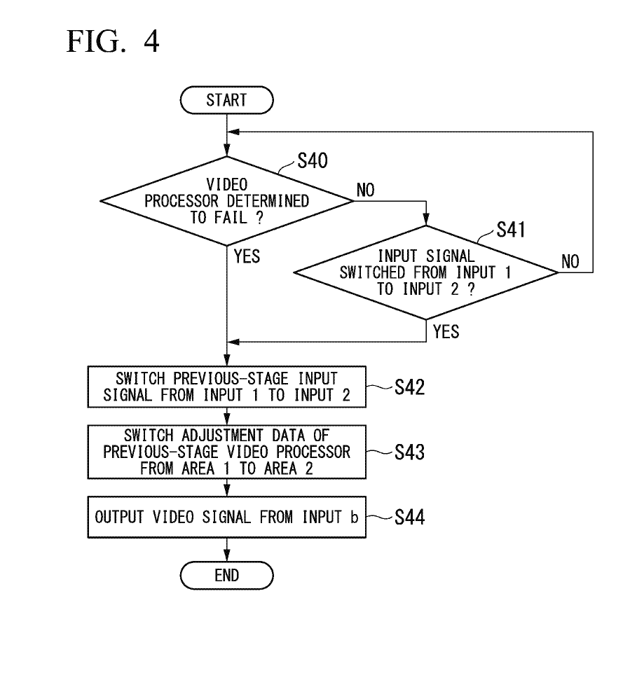

Next, a series of processes to be executed when the video data determination part 16_1 determines that the video processor 12_1 fails will be described. FIG. 4 is a flowchart showing a series of processes to be executed when it is determined that the video processor 12_1 fails. Similar to the video data determination part 16_1, the video data determination part 16_2 carries out a series of processes when determining that the video processor 12_2 fails. Descriptions regarding part of processes executed by the video data determination part 16_2, which are similar to a series of processes executed by the video data determination part 16_1, will be omitted here, and therefore another part of processes executed by the video data determination part 16_2, which are not executed by the video data determination part 16_1, will be described below.

As shown in FIG. 4, when the video data determination part 16_1 determines that the video processor 12_1 fails (i.e. YES in step S40), the video data determination part 16_1 outputs the first video signal from the previous-stage redundant input switcher 94 (step S44).

When the video data determination part 16_2 determines that the video processor 12_2 fails (i.e. YES in step S40), the video data determination part 16_2 controls the previous-stage input signal switcher 14_1 such that the video processor 12_1 inputs the second input signal (step S42). In addition, the input signal switcher 14_1 switches the adjustment data used for vide processing from the adjustment data of the first input signal to the adjustment data of the second input signal (step S43).

The video data determination part 16_1 outputs to a display device the first video signal produced by the previous-stage redundant input switcher 94.

Then, the video data determination part 16_1 exits a series of processes shown in the flowchart of FIG. 4.

When the video data determination part 16_1 determines that the video processor 12_1 did not fail (i.e. NO in step S40), the video data determination part 16_1 determines whether the input signal of the video processor 12_1 is the first input signal or the second input signal (step S41). When the video data determination part 16_1 determines that the input signal of the video processor 12_1 is the first input signal (i.e. NO in step S41), the video data determination part 16_1 proceeds back to step S40. When the video data determination part 16_1 determines that the input signal of the video processor 12_1 is the second input signal (i.e. YES in step S41), the video data determination part 16_1 proceeds to step S42.

As described above, even when the video signal output circuit 10_1 determines that the video processor 12_1 fails, the video signal output device 1 of the present embodiment is configured to output the first video signal from the previous-stage redundant circuit 9 instead of the first video signal from the input signal switcher 14_1. Accordingly, it is possible for the video signal output circuit 10_1 to continuously output the first video signal even when it is determined that the video processor 12_1 fails.

Even when the video processor 12_1 cannot generate the first video signal any longer since the first input signal is input to the video processor 12_1, it is possible for the video signal output circuit 10_1 to continuously output the first video signal by outputting the first video signal from the previous-stage redundant circuit 9.

In the present embodiment, it is possible to further connect a plurality of video signal output circuits 10_3 through 10_n following the video signal output circuit 10_2. When a video signal output circuit 10_k, i.e. any one of the video signal output circuits 10_1 through 10_n, has a video processor 12_k which fails, a video signal switcher 18_k controls a previous-stage input signal switcher 14_k-1 to generate a k video signal, thus outputting the k video signal generated by the input signal switcher 14_k-1. In this case, the video signal switcher 18_k-1 controls a previous-stage input signal switcher 14_k-2 to generate a k-1 video signal, thus outputting the k-1 video signal generated by the input signal switcher 14_k-2.

As described above, even when the video signal output circuit 10_k, i.e. any one of the video signal output circuits 10_1 through 10_n, has the video processor 12_k which fails, the video signal output circuit 10_k and its previous-stage video signal output circuits 10_1 through 10_k-1 control the redundant circuit 9 or the input signal switchers 14_1 through 14_k-1 to generate video signals which have been output by themselves, thus outputting those video signals, whereby it is possible to continuously output video signals which have been output by themselves.

In addition, the video processors 12_0 through 12_2 may achieve functions as tuners or set-top boxes by generating video signals according to input signals of cable television broadcasting, satellite broadcasting, terrestrial television broadcasting (e.g. digital broadcasting, analog broadcasting).

For example, input signals may correspond to composite video signals, S-video signals, component signals, RGBHV (RGB (color signals), horizontal synchronization signals, and vertical synchronization signals), DVI (Digital Visual Interface), HEMI (High-Definition Multimedia Interface (trademark registration)), DisplayPort, and the like.

In addition, for example, video signals generated by the video processors 12_0 through 12_2 according to the aforementioned input signals may comply with data transmission standards such as LVDS (Low Voltage Differential Signaling), V by One (trademark registration), and HD base-T (trademark registration).

Next, the second embodiment will be described below. The second embodiment has the configuration similar to the first embodiment of FIG. 1, in which the redundant circuit 9 is replaced with an equivalent circuit of the video signal output circuit 10.

In the following descriptions, a plurality of video signal output circuits 10_1 through 10_n will be collectively referred to as the video signal output circuit 10. In addition, the constituent elements constituting a plurality of video signal output circuits 10_1 through 10_n and the circuits connected to a plurality of video signal output circuits 10_1 through 10_n will be given their generic terms such that, for example, a plurality of video processors 12_1 through 12_n will be collectively referred to as the video processor 12.

Since the redundant circuit 9 has the same configuration as the video signal output circuit 10, the video signal output device 1 may utilize the redundant circuit 9 as a redundant circuit adapted to a plurality of video signal output circuits 10, or the video signal output device 1 may utilize the redundant circuit 9 as a video signal output circuit. Since the redundant circuit 9 has the same configuration as the video signal output circuit 10, it is possible for the video signal output device 1 to flexibly change the number of video signal output circuits 10 each used for the redundant circuit 9 and the number of video signal output circuits 10 used for themselves, among a plurality of video signal output circuits 10, according to reliability and device costs.

When the video signal output device 1 includes nine video signal output circuits 10, for example, a ratio between “the number of video signal output circuits 10” and “the number of redundant circuits 9” may be set to X=8:1, whereby it is possible to output the maximal types of video signals with redundancy. When the ratio is set to X=6:3, it is possible to realize the configuration in which a single redundant circuit 9 is provided for two video signal output circuits 10, thus improving redundancy. When the ratio is set to X=5:4, it is possible to further improve redundancy, wherein it is possible to continuously output video signals even when four video signal output circuits 10 among five video signal output circuits 10 may fail.

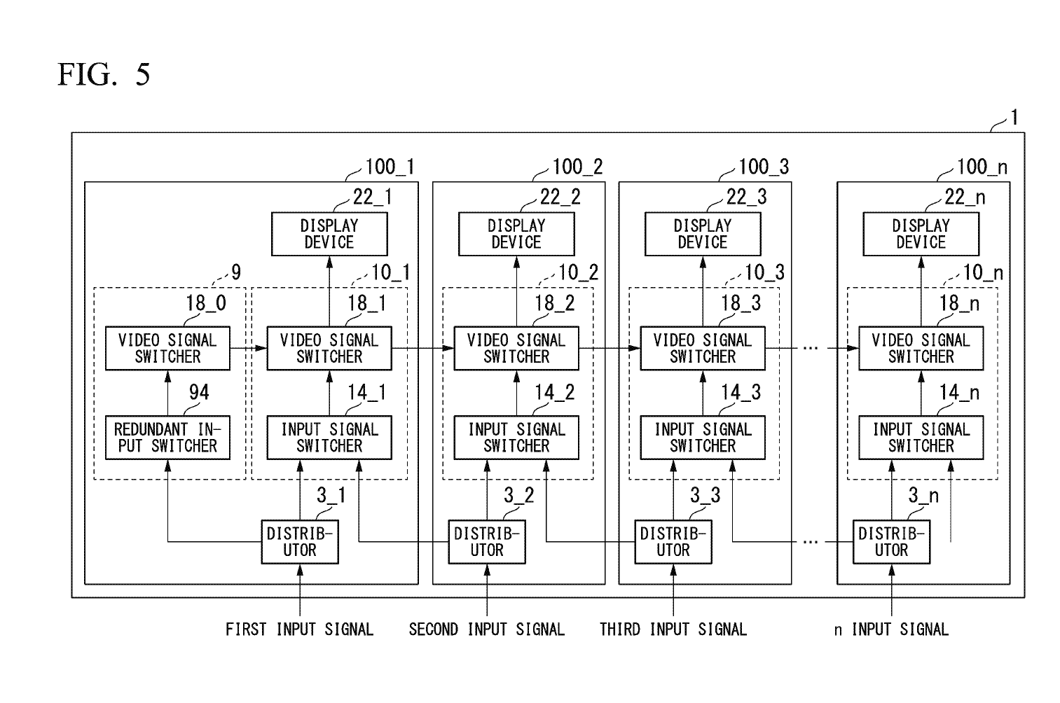

Next, the third embodiment will be described with reference to FIG. 5. FIG. 5 is an explanatory diagram for explaining the third embodiment. As shown in FIG. 5, the third embodiment is configured using multiple-stage series connection of n monitors 100_1 through 100_n (hereinafter, collectively referred to as the monitor 100).

The monitor 100 is configured such that the video signal output circuit 10 according to the first embodiment is integrally combined with a distributor 3 and a display device 22, and therefore the monitor 100 will be finished as a monitor product. In the forefront-stage monitor 100_1, the redundant circuit 9 is connected to the video signal output circuit 10 at a different side than the monitor 100_2 connected to the monitor 100_1, and therefore the monitor 100_1 will be finished as a monitor product equipped with a redundant circuit.

The distributor 3 divides a single input signal so as to distribute multiple signals. In FIG. 5, a distributor 3_1 distributes a first input signal to the redundant circuit 9 and the video signal output circuit 10_1. A distributor 3_2 distributes a second input signal to the video signal output circuit 10_1 and a video signal output circuit 10_2. Accordingly, each distributor 3_k distributes an input signal for a video k to each video signal output circuit 10_k configured to output a video signal for the video k, while each distributor 3_k distributes an input signal for the video k to a previous-stage video signal output circuit 10_k-1 to prepare for the situation that a video processor 12_k of the video signal output circuit 10_k fails and for the situation that the video processor 12_k generates a video signal for a video k+1 output from its latter-stage circuit.

The display device 22 includes a screen used to display a video according to a video signal. For example, the display device 22 may include a liquid-crystal display or an organic EL (Electro-Luminance) display.

According to the third embodiment, it is possible to freely combine the number of monitor products and the number of monitor products equipped with redundant circuits according to redundancy required by users.

Next, the fourth embodiment will be described below.

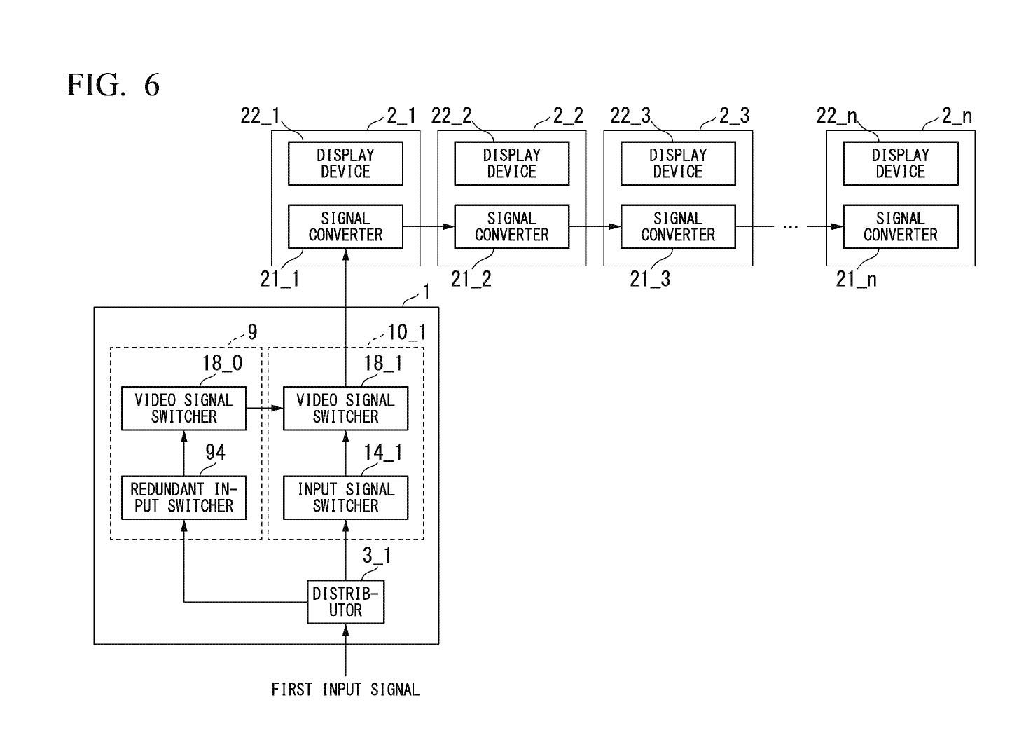

FIG. 6 is an explanatory diagram for explaining the fourth embodiment. As shown in FIG. 6, the video signal output circuit 10_1 according to the first embodiment is connected with n display device units 2_1 through 2_n. The video signal output circuit 10_1 outputs a video signal to the display device unit 2.

The display device unit 2 includes a signal converter 21 and a display device 22. The signal converter 21 is configured to convert signals according to the display device 22, for example, the signal converter 21 carries out a conversion process to render a color indicated by a video signal on the display device 22. The display device 22 includes a screen to display a video.

The video signal output circuit 10_1 is connected to the redundant circuit 9 and the distributor 3_1.

A first input signal is supplied to the redundant circuit 9 through the distributor 3_1. Thus, it is possible for the video processor 12_0 of the redundant circuit 9 to generate a first video signal when the video processor 12_1 of the video signal output circuit 10_1 fails.

According to the fourth embodiment, the video signal output circuit 10_1 generates the first video signal according to the first input signal and thereby delivers the first video signal to the n display device units 2_1 through 2_n. The n display device units 2_1 through 2_n displays the same first video signal.

The fourth embodiment has the configuration to include a single video signal output circuit 10 and a single redundant circuit 9 in connection with a plurality of display device units 2, and therefore it is possible to provide redundancy while reducing overall costs for each device.

Next, the fifth embodiment will be described below.

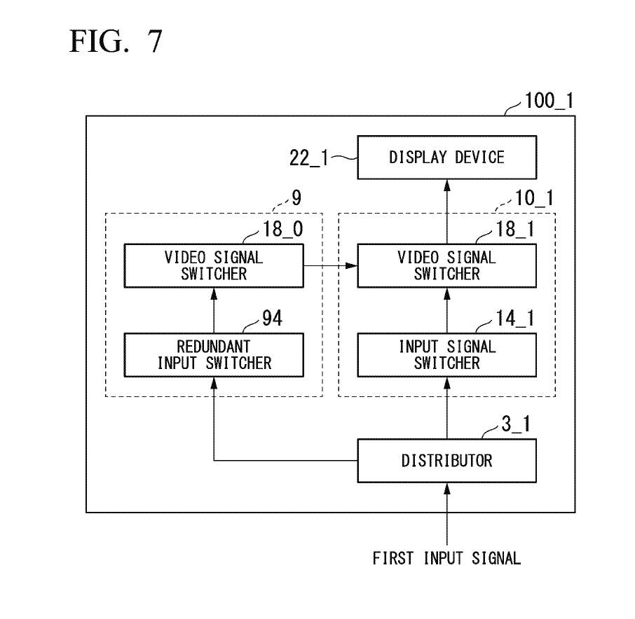

FIG. 7 is an explanatory diagram for explaining the fifth embodiment. As shown in FIG. 7, the fifth embodiment has the configuration in which the video signal output circuit 10_1 of the first embodiment is integrally combined with the distributor 3_1 and the display device 22_1. In addition, the redundant circuit 9 is connected to the video signal output circuit 10_1, and therefore the fifth embodiment is finished as a monitor product equipped with a redundant circuit.

The fifth embodiment provides a monitor product equipped with a single redundant circuit in connection with a single display device, thus realizing redundancy.

Next, the sixth embodiment will be descried below.

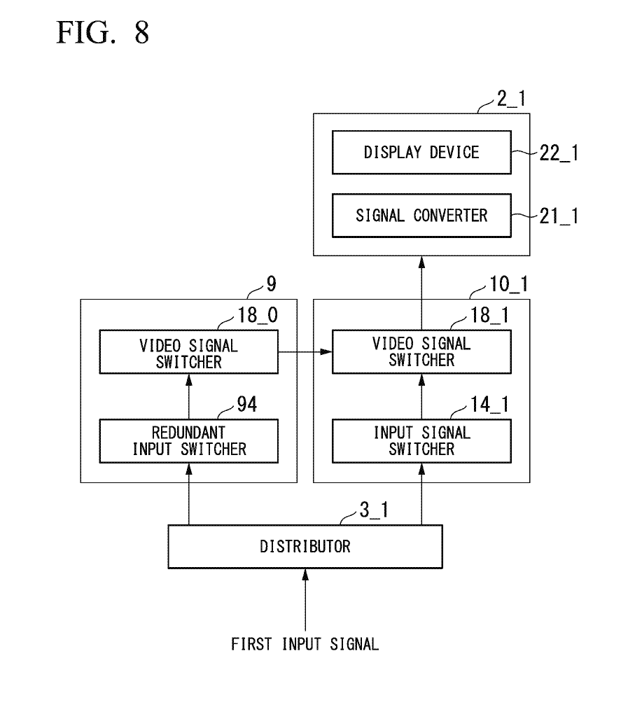

FIG. 8 is an explanatory diagram for explaining the sixth embodiment. As shown in FIG. 8, the sixth embodiment has the configuration in which the video signal output circuit 10_1 of the first embodiment is connected with the display device unit 2_1. In addition, the video signal output circuit 10_1 is connected to the redundant circuit 9 and the distributor 3_1.

The sixth embodiment provides a single display unit 2 with a single video signal output circuit 10 and a single redundant circuit 9, thus realizing redundancy. In addition, the display device unit 2_1, the video signal output circuit 10_1, the redundant circuit 9, and the distributor 3_1 are designed as independent units. This makes it possible for user to freely combine those units.

Next, the seventh embodiment will be described below.

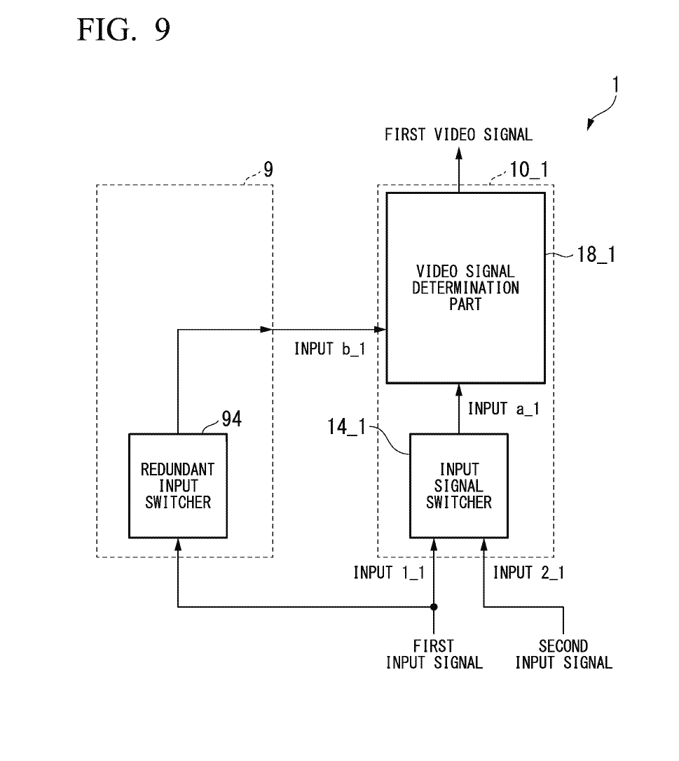

FIG. 9 is an explanatory diagram for explaining the seventh embodiment. As shown in FIG. 9, the seventh embodiment includes the redundant circuit 9 and the video signal output circuit 10_1. The redundant circuit 9 includes the redundant input switcher 94. Upon inputting a first input signal, the redundant input switcher 94 generate a first video signal according to the first input signal. The video signal output circuit 10_1 includes the input signal switcher 14_1 and the video signal switcher 18_1. Upon inputting a first input signal and a second input signal, the input signal switcher 14_1 generates either a first video signal according to the first input signal or a second video signal according to the second input signal. The video signal switcher 18_1 receives the first video signal from the redundant input switcher 94 while receiving the first video signal or the second video signal from the input signal switcher 14_1, thus outputting the first video signal generated by the redundant input switcher 94 or the input signal switcher 14_1.

### REFERENCE SIGNS LIST

1 video signal output device
10 video signal output circuit
11 input signal switch
12 video processor
14 input signal switcher
15 video signal switch
16 video data determination part
18 video signal switcher
2 display device unit
21 signal converter
22 display device
3 distributor
9 redundant circuit
94 redundant input switcher
100 monitor

1. A video signal output device comprising a redundant circuit and a first video signal output circuit,
wherein the redundant circuit includes a redundant input switcher configured to input a first input signal and to thereby generate a first video signal according to the first input signal, and
wherein the first video signal output circuit includes a first input signal switcher configured to input the first input signal and a second input signal and to thereby generate either the first video signal or a second video signal according to the second input signal, and a first video signal switcher configured to input the first video signal from the redundant input switcher while inputting the first video signal or the second video signal from the first input signal switcher and to thereby output the first video signal generated by the redundant input switcher or the first input signal switcher.

2. The video signal output device according to claim 1, further comprising a second video signal output circuit, wherein the second video signal output circuit includes a second input signal switcher which, upon solely inputting the second input signal, generates the second video signal and which, upon inputting the second input signal and a third input signal, generates either the second video signal or a third video signal according to the third input signal, and a second video signal switcher configured to input the first video signal or the second video signal from the first input signal switcher while inputting the second video signal or the third video signal from the second input signal switcher and to thereby output the second video signal generated by the first input signal switcher or the second input signal switcher.

3. The video signal output device according to claim 2, wherein when the first input signal switcher generates the second video signal, the second video signal switcher outputs the second video signal generated by the first input signal switcher while the first video signal switcher outputs the first video signal generated by the redundant input switcher.

4. The video signal output device according to claim 2 or 3, wherein when the second input signal switcher fails, the second video signal switcher controls the first input signal switcher to generate the second video signal.

5. The video signal output device according to claim 2 or 3, wherein when the second input signal switcher generates third video signal, the second video signal switcher controls the first input signal switcher to generate the second video signal.

6. The video signal output device according to any one of claims 1 to 3, wherein the first video signal switcher determines that the first input signal switcher fails when the first input signal switcher generates a video signal precluding a predetermined signal.

7. The video signal output device according to any one of claims 1 to 3, wherein the second video signal switcher determines that the second input signal switcher fails when the second input signal switcher generates a video signal precluding a predetermined signal.

8. (canceled)

9. The video signal output device according to any one of claims 1 to 3, wherein the first video signal switcher determines that the first input signal switcher fails when the first input signal switcher generates a video signal corresponding to a video signal of a full-black video.

10. The video signal output device according to any one of claim 2 or 3, wherein the second video signal switcher determines that the second input signal switcher fails when the second input signal switcher generates a video signal corresponding to a video signal representing a full-black video.

11. A display system comprising:
a video signal output device according to any one of claims 1 to 3; and
a display configured to input a video signal from the video signal output device and to thereby display a video corresponding to the video signal.

12. A video signal output method adapted to a video signal output device including a redundant circuit and a first video signal output circuit, comprising:
applying a first input signal to the redundant circuit and thereby generating a first video signal according to the first input signal;
applying the first input signal and a second input signal to the first video signal output circuit and thereby generating the first video signal or a second video signal according to the second input signal; and
inputting the first video signal generated in the redundant circuit while inputting the first video signal or the second video signal generated in the first video signal output circuit and thereby outputting the first video signal generated in the redundant circuit or the first video signal output, circuit.

13. The video signal output device according to any one of claims 1 to 3, wherein the first video signal switcher determines that the first input signal switcher fails when the first input signal switcher generates a video signal precluding a predetermined signal corresponding to at least any one of a clock signal, a data enable signal, and a synchronization signal.

14. The video signal output device according to any one of claims 1 to 3, wherein the second video signal switcher determines that the second input signal switcher fails when the second input signal switcher generates a video signal precluding a predetermined signal corresponding to at least any one of a clock signal, a data enable signal, and a synchronization signal.
